(19) United States
(12) Patent Application Publication
(10) Pub. No.: US 2012/0254132 A1
(43) Pub. Date: Oct. 4, 2012

(54) Enhanced Contact Information

(75) Inventors: Kimmo Kivirauma, Kangasala (FI); Rami Lehtonen, Toijala (FI)

(73) Assignee: TeliaSonera AB

(21) Appl. No.: 13/430,988

(22) Filed: Mar. 27, 2012

(30) Foreign Application Priority Data
Mar. 28, 2011 (EP) 11159999.9

(51) Int. Cl. G06F 17/30

(52) U.S. Cl. 707/692; 707/758; 707/737; 707/E17.002; 707/E17.046

(57) ABSTRACT

A method and an apparatus for organizing information in an electronic address book. The method comprises collecting contact information for an electronic address book, comparing a name from any field in said contact information to a database comprising name information, identifying a first name or a surname from the contact information and relocating in the contact information the identified first name to a field assigned to first names or the surname to a field assigned to surnames as a response to a name identified in a wrong field.

### CROSS-REFERENCE TO RELATED PATENT APPLICATIONS

The present application claims priority to European Patent Office Priority Application 11159999.9, filed Mar. 28, 2011. The specification, drawings, claims and abstract of this application is incorporated herein by reference in its entirety.

### BACKGROUND

The invention relates to mobile communications. More particularly, the present invention relates to electronic address books used for example in mobile phones.

Managing the contact information in mobile phones requires a lot of manual work. Contact information may be stored in a non-efficient and non-uniform way. For example names may be written in lowercase letters, wrong fields or in capital letters (e.g. contact A first name=“alice jones”, contact B surname=“smith bob”, contact C firstname=“CHARLIE” lastname=“JONES”).

The contact book may contain tens or even hundreds of contacts. It is important for the user of a mobile phone to be able to find the most relevant contact information as quickly as possible.

The prior art offers tools to organize contact information in various ways and enrich the information from different sources. For example U.S. Pat. No. 7,711,106 discloses adding contacts to a personal network address book by extracting a telephone number from a billing database/call data record storage unit if information meets preset criteria and adding extracted number to address book.

### SUMMARY

The purpose of the invention is to present a new method and apparatus for organizing information in an electronic address book. The invention improves the user experience when using the address book of the mobile phone. Properly arranged address book improves also known methods and applications for utilizing it, as the information is stored in standardized manner.

The invention discloses a method and apparatus for enhancing contact information for an electronic address book. The method comprises the steps of collecting contact information for an electronic address book; comparing a name from any field in said contact information to a database comprising name information; identifying a first name or a surname from the contact information; and relocating in the contact information the identified first name to a field assigned to first names or the surname to a field assigned to surnames as a response to a name identified in a wrong field. This method organizes both first and surnames to the fields assigned for them. The database may comprise all common first names for recognizing the character string of a first name. The surname may be the unidentified portion of the name or a common surname found in the database.

In one embodiment, the contact information is standardized also by capitalizing the first name or the surname in the contact information. This method applies when the name has been stored to the address book with more than one upper-case letter in the beginning or without the upper-case letter in the beginning. Common parts of a name that are commonly written in lower-case letters may not be converted. Examples of such parts are “de,” “von,” “la,” etc.

In one embodiment, duplicate contacts are identified in different contact information entries. These are combined to single contact information. One person may have several contact information entries with different fields filled in. In this manner, all information relating to one person can be found under single contact information.

In one embodiment, the phone number format of the contact information is converted to a predefined international format. Many times the user may store a phone number in domestic format without the international portion, for example +358 in Finland. The predetermined format refers to the mobile operator's country where the majority of user's contacts are presumably located or the user may define the country. For the user, this may be presented as a flag of the country, since it is not necessary for the user to know the actual country codes.

In one embodiment, contact information is collected to a computer connected to Internet from a mobile communication apparatus. The mobile communication apparatus, such as a mobile phone is connected to an Internet service. The electronic address book of the mobile phone is modified via a web page.

In one embodiment, at least two sets of contact information are grouped based on similar name field content or other similar field, e.g. similar email address, similar phone number and information obtained from at least one external database comprising similar information.

The invention discloses also an apparatus for communication, comprising at least one processor and at least one memory comprising program code, wherein the at least one memory and the computer program code are configured to, with the at least one processor, cause the apparatus to execute the steps of the method claims according to the invention. The invention discloses also a computer program, comprising code for collecting contact information for an electronic address book; code for comparing a name from any field in said contact information to a database comprising name information; and code for identifying a first name or a surname from the contact information when the computer program is run on a processor. Also, in one aspect of the invention, the computer program is a computer program product comprising a computer-readable medium bearing computer program code embodied therein for use with a computer.

The benefits of the invention are better user experience for a mobile phone's electronic address book. The address book may be modified at a large computer screen instead of a limited mobile screen. The invention also improves the functionality of electronic address book when used by or with other applications comprising automated processes.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram of an example embodiment of the present invention, and

FIG. 2 is an example of a web service according to the present invention.

### DETAILED DESCRIPTION OF VARIOUS EMBODIMENTS

Reference will now be made in detail to the embodiments of the present invention, examples of which are illustrated in the accompanying drawings.

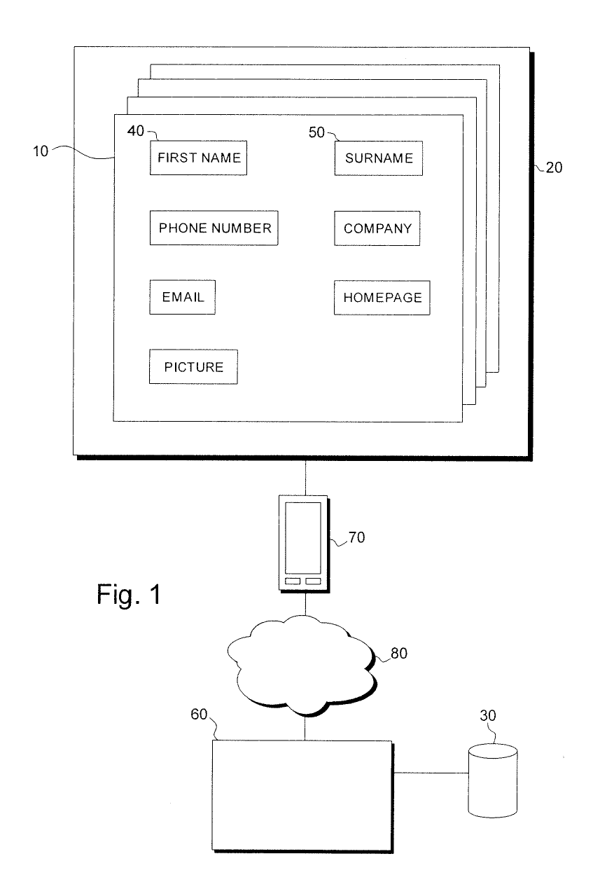

FIG. 1 illustrates a simplified block diagram comprising the elements related to the present invention. An electronic address book 20 is used for example with mobile devices 70 such as mobile phones, PDA devices and such. The electronic address book 20 is used for storing contact information 10 about friends, family members, colleagues, business contacts, etc. A single contact information entry 10 comprises several information elements or data fields for the contact, such as the first name, surname, phone number to one or more subscription, company name, Internet URL, picture or alike.

The mobile device 70 may be connected to Internet 80 via data network in any method known in the art. A computer 60 may be configured to connect to the mobile device 70 via Internet. In another embodiment, the mobile device 70 is connected to the computer 60 via separate cable, and the data transfer is executed by synchronizing the mobile device 70 with the computer 60. In yet another embodiment, the mobile device 70 is connected to a second computer via cable and the second computer is connected to the computer 60 via the Internet. The synchronization can be done locally to a second computer, which handles the data transfer to the computer 60. The electronic contact book 20 can be transferred from the mobile device 70 to the computer 60 with known methods such as SyncML/OMADS protocol.

The computer 60 is connected to a database 30, which comprises name information. The name information comprises most common first names and surnames. Names may comprise several nationalities and the computer or the database may comprise means for differentiating different names in different contexts.

The contact information 10 is collected to the computer 60 by one or more entries or by a complete electronic address book 20 comprising all available contact informations 10 from the mobile device 70. In one embodiment, the computer 60 is configured to operate as a web service comprising a user interface available to the user of the mobile device 70. The web service 60 compares the collected names to the database 30 and identifies either the first names or surnames from the contact information 10. The database 30 may be a single entity, distributed to several databases or comprise from separate databases. If the identification indicates that a first name or a surname is in the wrong field, the web service 60 proposes a correction to the user. The user may then accept or reject the proposed correction via the user interface. In one embodiment, the operation is automatic such that the user is not prompted to verify all changes or at least part of the changes.

The computer or web service 60 may also comprise other applications for enhancing the electronic address book 20. Sometimes the user may have stored the names in all lower-case letters or all capital letters. The web service is configured to recognize the situation, where a name comprises more than one capital letter or a lower-case letter in the beginning. The web service 60 proposes a correction to the user, which the user may accept or reject or the functionality may be implemented without the need of user interaction in all steps. Duplicate contacts may be combined together and the user is requested to decide the correct form of the combined contact information. Phone numbers lacking an international number format are also converted to comprise the prefix for an international format. The default international code offered by the service may be the home operator's own country code or any other code that the user may submit to the system. The user can also easily select an international code for a contact's phone number by selecting a flag icon representing certain country accordingly. The system has a database which maps the flag icons to the appropriate international code.

After all necessary modifications have been made to the contact information 10 or the complete electronic address book 20, the modified contact information 20 is transferred or synchronized back to the mobile device 70.

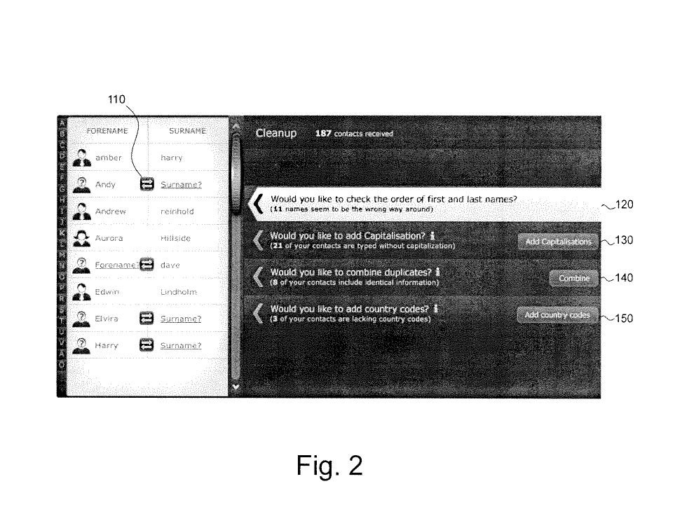

FIG. 2 illustrates an example of a web service according to the present invention. The user interface prompts the user to examine the order of first names and last names, i.e. surnames, shown at block 120. Possible candidates have been highlighted by an arrow symbol 110. The user may change the position of the first name and the surname by clicking the arrow 110.

The user may also select other means to modify the electronic address book 20. Block 130 enables the capitalization of the contact information 10, where the first letter of a name is modified to uppercase letter and the rest are modified to lowercase letters. Block 140 enables the search for duplicate contacts, where different information is contained by separate items of contact information 10 having similar names are combined to a single contact information 10. Block 150 enables adding a country code to contact information 10.

The user interface according to FIG. 2 may be implemented on a computer 60 that is hosting the web service. It may also be implemented into the mobile phone 70, where the connections between the electronic address book 20 and the computer 70 are implemented by the internal circuitry of the mobile phone 70.

Embodiments of the present invention may be implemented in software, hardware, application logic or a combination of software, hardware and application logic. In an example embodiment, the application logic, software or instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer. The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be conveniently implemented using one or more general purpose processors, microprocessors, digital signal processors, micro-controllers, and the like, programmed according to the teachings of the exemplary embodiments of the present inventions, as will be appreciated by those skilled in the computer and/or software art(s). Appropriate software can be readily prepared by programmers of ordinary skill based on the teachings of the exemplary embodiments, as will be appreciated by those skilled in the software art. In addition, the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware and/or software.

If desired, the different functions discussed herein may be performed in a different order and/or concurrently with each other.

Furthermore, if desired, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims.

What is claimed is:

1. A method, comprising using a computer to:
collect contact information for an electronic address book;
compare a name from any field in said contact information to a database comprising name information;
identify one of a first name and a surname from the contact information;
in the event that a first name has been identified from the contact information, relocate in the contact information the identified first name to a first field assigned to first names if the first name was identified as being in an incorrect field;
in the event that a surname has been identified from the contact information, relocate in the contact information the identified surname to a second field assigned to surnames as if the surname was identified as being in an incorrect field.

2. The method according to claim 1, further comprising using the computer to capitalize one of a first name and a surname in the contact information.

3. The method according to claim 1, further comprising using the computer to identify duplicate contacts in different contact information entries and combine said contact information entries into a single contact information entry.

4. The method according to claim 1, further comprising using the computer to convert a phone number format of the contact information to a predefined international format.

5. The method according to claim 1, wherein the contact information is collected at the computer which is connected a mobile communication apparatus via the Internet.

6. The method according to claim 1, further comprising using the computer to group at least two sets of contact information based on similar name field content and information obtained from at least one external database comprising similar information.

7. An apparatus for communication, comprising:
at least one processor; and
at least one memory communicatively connected to the process, the at least one memory comprising program code, wherein the at least one memory and the computer program code are configured to, with the at least one processor, cause the apparatus to:
collect contact information for an electronic address book;
compare a name from any field in said contact information to a database comprising name information;
identify one of a first name and a surname from the contact information;
in the event that a first name has been identified from the contact information, relocate in the contact information the identified first name to a first field assigned to first names if the first name was identified as being in an incorrect field;
in the event that a surname has been identified from the contact information, relocate in the contact information the identified surname to a second field assigned to surnames as if the surname was identified as being in an incorrect field.

8. The apparatus according to claim 7, wherein the at least one memory and the computer program code are further configured to, with the at least one processor, cause the apparatus to capitalize one of a first name and a surname in the contact information.

9. The apparatus according to claim 7, wherein the at least one memory and the computer program code are further configured to, with the at least one processor, cause the apparatus to identify duplicate contacts in different contact information entries and combine said contact information entries into a single contact information entry.

10. The apparatus according to claim 7, wherein the at least one memory and the computer program code are further configured to, with the at least one processor, cause the apparatus to convert the phone number format of the contact information to a predefined international format.

11. The apparatus according to claim 7, wherein the apparatus comprises a computer connected to the Internet, and wherein the at least one memory and the computer program code are further configured to, with the at least one processor, cause the apparatus to collect contact information from a mobile communication apparatus.

12. The apparatus according to claim 7, wherein the apparatus comprises a mobile communication apparatus, and wherein the at least one memory and the computer program code are further configured to, with the at least one processor, cause the apparatus to collect name information from the database connected to the mobile apparatus by a wireless data network.

13. The apparatus according to claim 7, wherein the at least one memory and the computer program code are further configured to, with the at least one processor, cause the apparatus to group at least two sets of contact information based on similar name field content and information obtained from at least one external database comprising similar information.

14. A computer program product, embodied in a tangle computer-readable medium, comprising computer code for, when the computer program is run on a processor:
collecting contact information for an electronic address book;
comparing a name from any field in said contact information to a database comprising name information; and
identifying one of a first name and a surname from the contact information.

15. The computer program product according to claim 14, further comprising computer code for, when the computer program is run on the processor:
in the event that a first name has been identified from the contact information, relocating in the contact information the identified first name to a first field assigned to first names if the first name was identified as being in an incorrect field; and
in the event that a surname has been identified from the contact information, relocating in the contact information the identified surname to a second field assigned to surnames as if the surname was identified as being in an incorrect field.

16. The computer program product according to claim 14, further comprising computer code for, when the computer program is run on the processor, capitalizing one of a first name and a surname in the contact information.

17. The computer program product according to claim 14, further comprising computer code for, when the computer program is run on the processor, identifying duplicate contacts in different contact information entries and combining said contact information entries into a single contact information entry.

18. The computer program product according to claim 14, further comprising computer code for, when the computer program is run on the processor, converting a phone number format of the contact information to a predefined international format.

19. The computer program product according to claim 14, wherein the contact information is collected at the computer connected from a mobile communication apparatus via the Internet.

20. The computer program product according to claim 14, further comprising computer code for, when the computer program is run on the processor, grouping at least two sets of contact information based on similar name field content and information obtained from at least one external database comprising similar information.
